(19) United States
(12) Patent Application Publication
(10) Pub. No.: US 2009/0315310 A1
(43) Pub. Date: Dec. 24, 2009

(54) Gradually adjustable wheels

(76) Inventor: Jianhua Fan, Nashville, TX (US)

Correspondence Address: Jianhua Fan, 5800 Maudina Ave. C2, Nashville, TN, 37209, US

(21) Appl. No.: 12/456,329

(22) Filed: Jun. 16, 2009

Related U.S. Application Data
(60) Provisional application No. 61/132,053, filed on Jun. 16, 2008.

(51) Int. Cl. B60S 9/02; B60B 11/10

(52) U.S. Cl. 280/765.1; 280/767

(57) ABSTRACT

A easy stand bicycle, motor-cycle, scooter, or electric-bicycle include a regular one of them, and at least two adjustable wheels with control system attached on them, so that, rider does not need standing on ground to support them on stop position. Also, main parts of a motor-cycle, scooter, or electric-bicycle with a car alike body can be made in a two wheels car, at least two adjustable wheels attached on the car, so that, rider can adjusts the adjustable wheels to support the car on stop position, and balance/support the car while making a turn.

### RELATED PATENT APPLICATION

The application claims the benefit of Provision U.S. Ser. No. 61,132,053, filed on Jun. 16, 2008, entitled “GRADUALLY ADJUSTABLE WHEELS” by Jianhua Fan.

### BACKGROUND OF THE INVENTION

1. Field of the Invention

The present invention relates to a bicycle with at least two additional adjustable wheels, more particularly relates to a bicycle with at least two additional gradually adjustable wheels, and furthermore particularly the two additional adjustable wheels can be used on motor-cycle, scooter and electric-bicycle, and can be made like a car.

2. The Perior Art

The bicycle, motor-cycle scooter and electric-bicycle existed on market are two wheels. While stop at intersection, the riders have to stand on ground to support it. Some children's bicycle have two small additional wheels on rear to support it but can not be adjusted.

It can be seen then that there is a need for a bicycle, motor-cycle, scooter and electric-bicycle with gradually adjustable wheels instead of feet to support them. It can further be seen that there is a possibility to make a motor-cycle, scooter, electric-bicycle like a car.

### SUMMARY OF THE INVENTION

The present invention relates to a bicycle, motor-cycle, scooter, and electric-bicycle with gradually adjustable wheels.

The present invention disclose a gradually adjustable wheel for bicycle, motor-cycle, scooter and electric-bicycle. The wheel is capable of being adjusted either traverse or vertical. Two or four adjustable wheels may be used in one bicycle, motor-cycle, scooter or electric-bicycle. It depends on the need. Also, the wheels can be adjusted separately for different proposal, such as balance or support the body while making a turn.

In one embodiment of the present invention, a bicycle with four adjustable wheels, two of them are fixed on front of the bicycle, and others two adjustable wheels are fixed on rear of the bicycle, the adjustable wheels are shown two positions: support position A, and no support position B, this means that the wheels are traverse adjusted, control of the adjustable wheels may be vary: such as by feet or by hands, also, location of the adjustable wheels may be vary, it can be located in middle of the bicycle.

Still in one embodiment, the adjustable wheels are vertical adjusted, and the method can be vary, for example, uses air pressure, oil pressure, or machinery/tension spring, even a electric motor to adjust the wheels, and use feet or hand to control the wheels. it is the same with regular bicycle or car.

Another embodiment, while a motor-cycle, scooter or an electric-bicycle is made in like a car, the adjustable wheels are located near the side/bottom of the body, and numeral of the wheels can be vary: such as two or four.

Still in another embodiment, the wheels can be adjusted separately for different proposal, for example, push down the wheel(s) on the right side and pull up the wheel(s) on the left side to balance the car while making a left turn.

These and various other advantages and feature of novelty which characterize the invention are pointed out with particularity in the claims annexed hereto and form a part hereof. However, for a better understanding of the invention, its advantage, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Refering now to the drawings in which like reference numbers represent corresponding parts throughout:

FIG. 1 is a side view of one embodiment of a bicycle with adjustable wheels in accordance with the principle of the present invention.

FIG. 2 is a front view of one embodiment of a bicycle with adjustable wheels those in no support position shown in FIG. 1

FIG. 3 is a front view of one embodiment of a bicycle with adjustable wheels those in support position shown in FIG. 1.

FIG. 4 is a perspective view of one embodiment of a motor cycle with adjustable wheels those in support position.

FIG. 5 is an adjustable wheel, the wheel is vertical adjusted.

FIG. 6 is a perspective view of another embodiment of a motor-cycle, scooter, electric-bicycle is made like a car with adjustable wheels, the wheels located on near side of the body.

FIG. 7 is a front view of one embodiment of a car like motor-cycle, scooter, electric-cycle with adjustable wheels those in support position.

FIG. 8 is a front view of one embodiment of a car like motor-cycle, scooter, electric-cycle with adjustable wheels those in no support position.

FIG. 9 is a back view of one embodiment of a car like motor-cycle, scooter, electric-cycle with adjustable wheels those are separately adjusted.

FIG. 10 is a back view of one embodiment of a car like motor-cycle, scooter, electric-cycle with adjustable wheels those are reverse adjusted of FIG. 9.

FIG. 11 is a side view of a car like motor-cycle, scooter or electric cycle with adjustable wheels, the wheels can be in middle or in front and rear of the body.

FIG. 12 is a adjustable wheels control pad combined on a steering wheel, while making a turn, an electric motor automatically adjusted the adjustable wheels,

### DETAILED DESCRIPTION OF THE PREFERRED EMBODIMENT

In the following description of the exemplary embodiment reference is made to the accompanying drawings which form a part hereof, and in which it is shown by way of illustration the specific embodiments maybe utilized as structural changes maybe made without departing from the scope of the present invention.

The present invention provides adjustable wheels for bicycle, motor cycle, scooter and electric bicycle, so that, a rider does not need to stand on ground to avoid fall while at stop situation, also, a motor cycle, scooter or electric bicycle can be made in like a car, using adjustable wheels to support the car at stop situation and balance the car on turning.

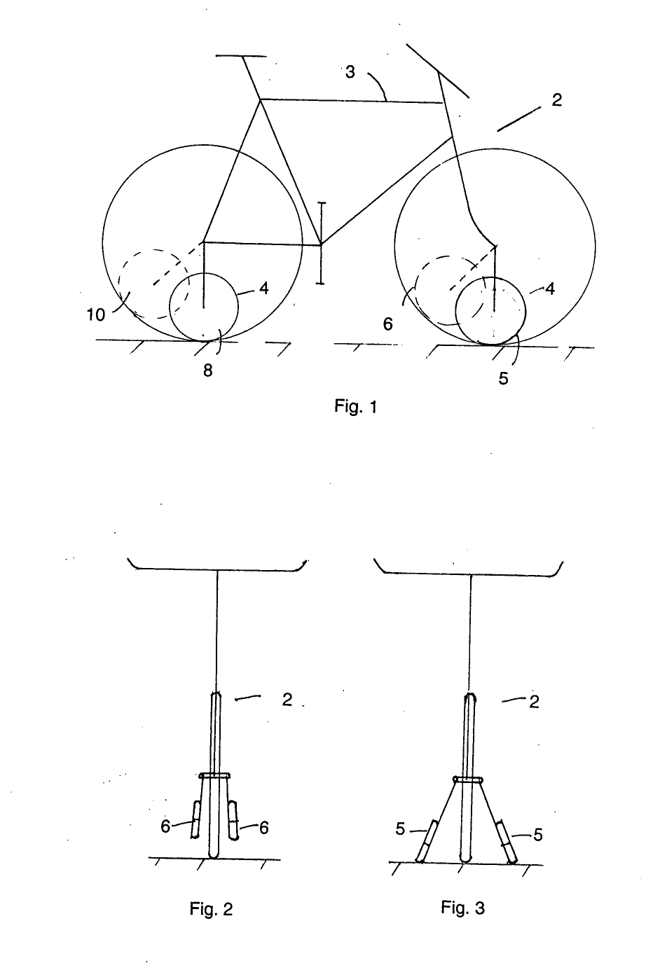

In FIG. 1 is generally illustrated by reference numeral 2, one embodiment of a bicycle with adjustable wheels apparatus in accordance with the principles of the present invention. The bicycle apparatus 2 includes a regular bicycle 3, and adjustable wheels 4, numeral 5 and 8 show the wheels on support position, numeral 6 and 10 show the wheels on no support position.

In FIG. 1, the wheel 4 can be located on front, rear, or near middle of the bicycle, such as numeral 7 ane 9's locations, the number of wheels can 2 or 4, it is depended on the needs.

Also in FIG. 1, the wheels controled either by hand or feet, that the same with regular bicycle or car.

FIGS. 2 and 3 are the front view of a bicycle with adjustable wheels, FIG. 2 show the wheels on no support position, and FIG. 3 show the wheels on support position, the shape of arm of the adjustable wheels can be vary, such as numeral 11.

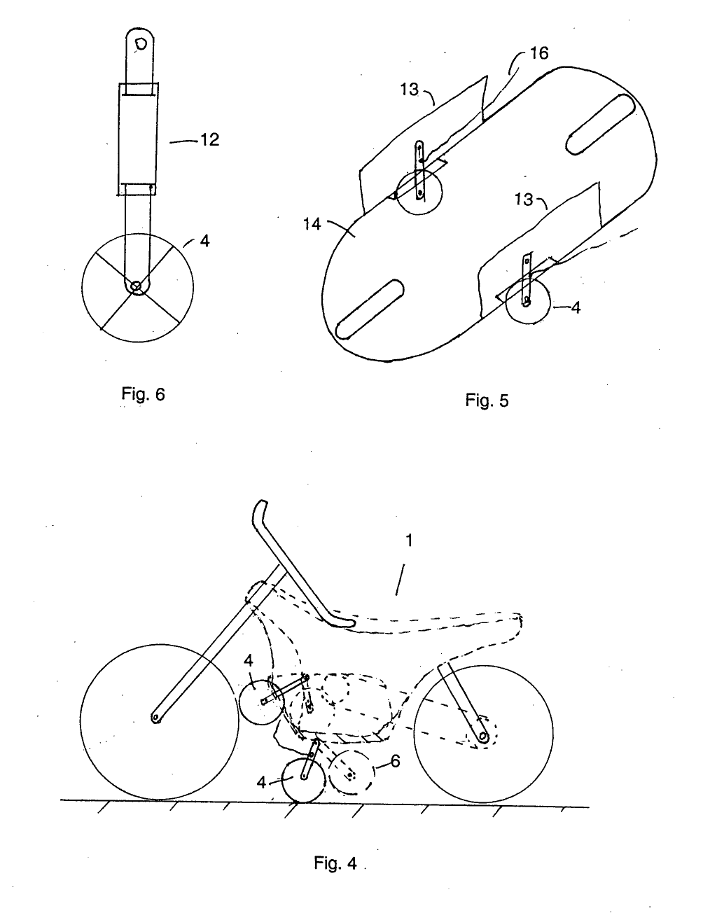

FIG. 4 shows the adjustable wheels 4 are located in middle, left and right side of a motor-cycle.

FIG. 5 illustrates a second embodiment of the adjustable wheel, in FIG. 5, the wheel is vertical adjusted, the methods of the adjustment can be vary, such as oil pressure, air pressure, electric controller, tension spring and more.

FIG. 6 illustrates the wheels located on bottom of a car alike motor-cycle, scooter, electric-cycle

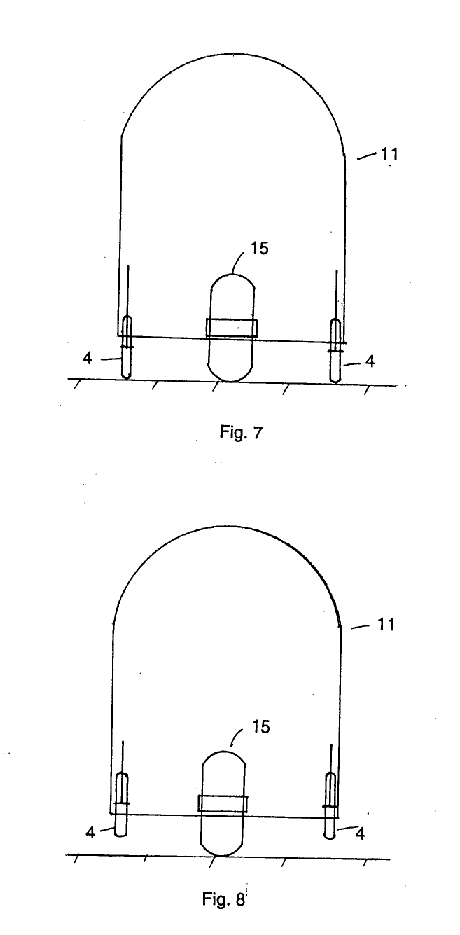

FIGS. 7 and 8 front show the wheels on side of a car alike motor-cycle, scooter, electrical cycle, wheels in FIG. 7 are on support position, and in FIG. 8 are on no support position.

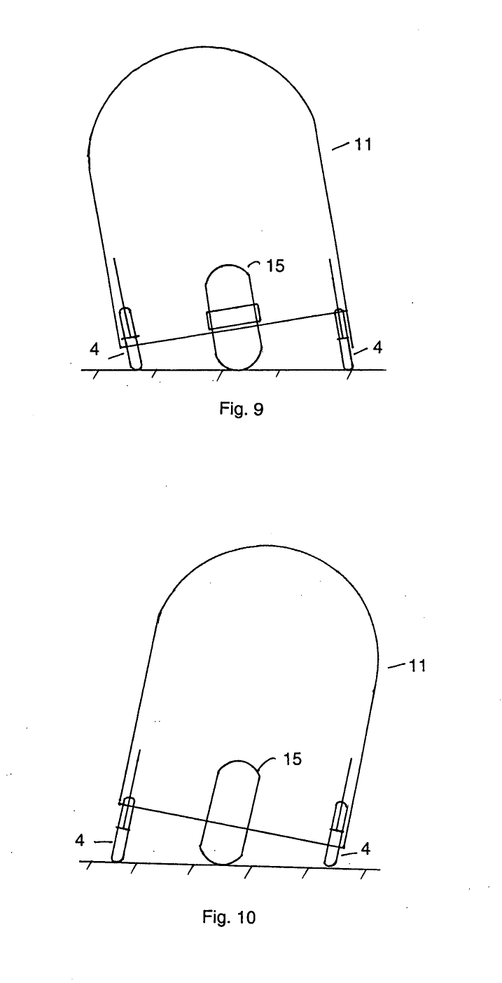

FIGS. 9 and 10 illustrate wheels those on separately adjusted positions, while a motor-cycle, scooter, electrical cycle is made a left or rifht turn, the wheels are separately adjusted to balance and support them.

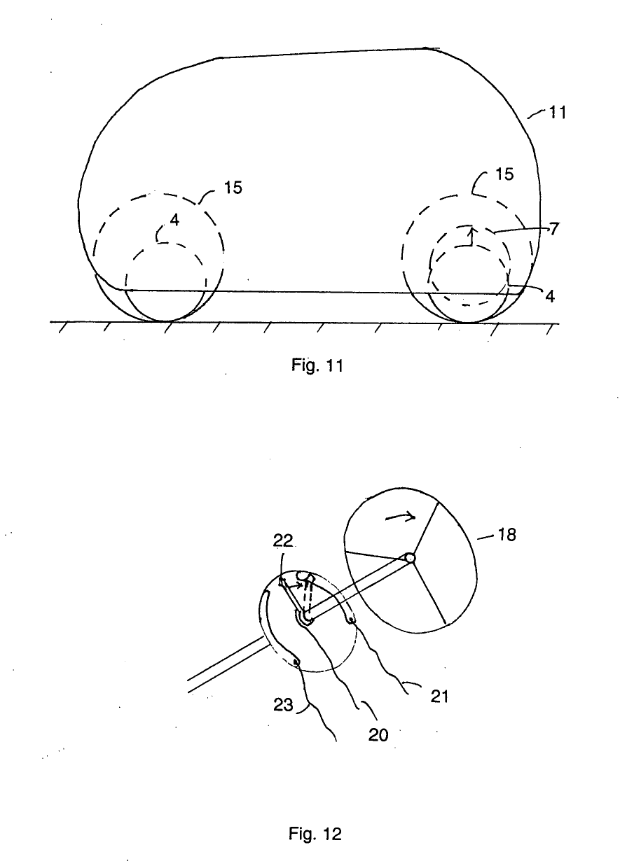

FIG. 11 shows the adjustable wheels can be located either on side or front, rear, middle.

FIG. 12 shows adjustable wheels controlled by electric motor through a steering wheel, while making a right turn, wire 22 reach part 21, and the wheel on left side gets lower, and the wheel on right side gets upper, the wheels and car body position looks like FIG. 10, while making left turn, the wheels and car body looks like FIG. 9.

There are too many control methods can be used either by hand, by feet, or by steering wheel/gripper, control methods do not illustrated all herewith because those are not a part of the present invention.

The foregoing description of the exemplary embodiment of the invention has been presented for the purposes of illustration and description. It is not intended to be exhaustive or to limit the invention to the precise form disclosed. Many modifications and variation are possible in light of the above teaching. It is intended that the scope of the invention be limited not with this detailed description, but rather by the claims.

1. A easy stand bicycle apparatus, comprising:
a regular bicycle (or a motor-cycle, scooter, electric-bicycle), and
at least two adjustable wheels, the at least two adjustable wheels attached to the regular bicycle (or motor-cycle, scooter, electric-bicycle), the adjustable wheels can be located either front, middle, or rear of the bicycle, the adjustable wheels include a wheel, an arm, a connect part and a control system.

2. The easy stand bicycle apparatus of claim 1, wherein the main parts control system include a wire and a tension spring.

3. The easy stand bicycle apparatus of claim 1, wherein the main pasts control system include an air, oil pressure striper combined with the arm.

4. A easy stand motor-cycle, scooter, or electric-bicycle apparatus, comprising:
main parts of a motor-cycle (or scooter, electric-bicycle), and
a car like body for the main parts of a motor-cycle (or scooter, electric-bicycle), made them in a two wheels car, and
at least two adjustable wheels, the adjustable wheels can be located on near side, either front, middle, or rear of the car like body, the adjustable wheels include a wheel, an arm, a connect part and a control system.

5. The easy stand motor apparatus of claim 4, wherein the main parts of control system include a wire and a tension spring.

6. The easy stand motor apparatus of claim 4, wherein the main parts of control system include an air or oil pressure stripper combined with the arm.

7. The easy stand motor apparatus of claim 4, wherein the main parts of control system include an electric-motor,
